(19) United States
(12) Patent Application Publication
(10) Pub. No.: US 2010/0283761 A1
(43) Pub. Date: Nov. 11, 2010

(54) PANEL MODULE AND DETECTING METHOD

(76) Inventor: Jeffson Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/776,440

(22) Filed: May 10, 2010

(30) Foreign Application Priority Data
May 11, 2009 (TW) 98115525

(51) Int. Cl. G06F 3/045

(52) U.S. Cl. 345/174

(57) ABSTRACT

A panel module and a detecting method are provided. A resistance value between two sides of a conducting layer of the panel module is measured. A dual touching event may be estimated according to the resistance value. Further, an input signal for controlling an electronic device may be generated according to the resistance value.

### CROSS-REFERENCE TO RELATED APPLICATION

This application claims the priority benefit of Taiwan application serial no. 98115525, filed on May 11, 2009. The entirety of the above-mentioned patent application is hereby incorporated by reference herein and made a part of specification.

### BACKGROUND OF THE INVENTION

1. Field of the Invention

The present invention relates to a dual touching technology, and more particularly, to a dual touching technology for a resistive touch panel.

2. Description of Related Art

Following the rapid development and application of the information technology, wireless mobile communication and information home appliances, many information products have started using a touch panel as an input device instead of the traditional input devices such as a keyboard or a mouse.

In terms of the driving type or structure design, touch panels are currently classified as resistive type, capacitor type, sound acoustic wave type, optical type, and so on. With respect to the resistive panel module, a user needs to physically depress the resistive panel module to cause sections inside the resistive panel module to be conducted to generate corresponding coordinate signals. Therefore, resistive panel modules suffer from a high damage rate. A single touching detecting technology used in the conventional resistive panel module is described below with reference to drawings.

FIG. 1A illustrates a touching principle of a conventional resistive touch panel module. Referring to FIG. 1A, the resistive touch sensor is formed by transparent uniform conducting layers L1, L2. The conducting layers L1, L2 are separated by a plurality of special supports SP. Each layer is connected to electrodes in a corresponding direction. For example, FIG. 1B illustrates a structure of conducting layers of a conventional four wire resistive panel module. In FIG. 1B, the conducting layers L1, L2 are connected to electrodes in X and Y dimensions. As another example, FIG. 1C illustrates a structure of conducting layers of a conventional five wire resistive panel module. In FIG. 1C, four corners of the conducting layer L2 are connected to electrodes UL, UR, BL, BR, respectively. The conducting layer L1 is connected to another electrode Sense.

FIG. 1D illustrates a sensing module of FIG. 1B. Referring to FIG. 1D, a voltage is applied to two ends of an electrode during sensing. When a user's finger touches the panel, the conducting layers L1, L2 contact with each other. The conducting layer that is not applied with a voltage senses a voltage signal which varies with different touching positions. Therefore, after the two conducting layers sense signals in the X and Y dimensions, respectively, data of the touching position can be obtained.

Thematically, no matter how many touching points on the touch panel, there is only one set of electrical signal values (X axis sensing signal plus a Y axis sensing signal) to compute one coordinate (X, Y). Therefore, the position coordinate can be correctly computed only if there is one touching point. The touching points cannot be detected in case there are two touching points. In other words, the conventional resistive panel module can only sense the touching point for a single touching event. The conventional resistive panel module is unable to respond to a multi-point touching situation. As a result, the conventional resistive panel module cannot satisfy the consumer's demand in versatility of product functions.

### SUMMARY OF THE INVENTION

Accordingly, the present invention is directed to a resistive touch panel module capable of detecting a dual touching event.

The present invention is also directed to a detecting method of a resistance touch panel which can detect a dual touching event thus facilitating the use of the resistive touch panel.

The present invention provides a resistive touch panel module including a touch panel first conducting layer, a touch panel second conducting layer, a first power source, a first resistance measuring unit, and an estimating unit. The touch panel first conducting layer and the touch panel second conducting layer contact with each other at a first unknown touching point and a second unknown touching point when a dual touching event takes place. The first power source is coupled to the touch panel first conducting layer. The first resistance measuring unit is coupled to the touch panel first conducting layer for measuring a first resistance value between two sides of the touch panel first conducting layer. The estimating unit is coupled to the first resistance measuring unit for estimating a first distance between a projection of the first unknown touching point and a projection of the second unknown touching point on a first direction based on the first resistance value.

In one embodiment of the present invention, the resistive touch panel module further includes a voltage detector. The voltage detector is coupled to the touch panel second conducting layer and the estimating unit for measuring a voltage of the touch panel second conducting layer and outputting the measured voltage to the estimating unit. The estimating unit may estimate a middle point projection position of a middle point between the first unknown touching point and the second unknown touching point projected on the first direction based on the voltage. The estimating unit may also estimate a first projection position of the first unknown touching point and a second projection position of the second unknown touching point projected on the first direction according to the middle point projection position and the first distance.

In one embodiment of the present invention, the resistance measuring unit comprises a resistance detector coupled to the two sides of the touch panel first conducting layer for measuring the first resistance value.

In one embodiment of the present invention, the resistance measuring unit comprises a current detector and a computing unit. The current detector is coupled to the touch panel first conducting layer for measuring a first current flowing through the touch panel first conducting layer. The computing unit is coupled to the current detector and the first power source to compute the first resistance value according to the first current and a voltage provided by the first power source.

In one embodiment of the present invention, the resistive touch panel module further comprises a second power source and a second resistance measuring unit. The second power source is coupled to the touch panel second conducting layer. The second resistance measuring unit is coupled to the touch panel second conducting layer and the estimating unit for measuring a second resistance value between the two sides of the touch panel second conducting layer and outputting the second resistance value to the estimating unit. The estimating unit may estimate a second distance between a projection of the first unknown touching point and a projection of the second unknown touching point on a second direction based on the second resistance value.

In another embodiment of the present invention, the resistive touch panel module further includes a voltage detector. The voltage detector is coupled to the touch panel first conducting layer and the estimating unit for measuring a voltage of the touch panel first conducting layer and outputting the measured voltage to the estimating unit. The estimating unit may estimate a middle point projection position of a middle point between the first unknown touching point and the second unknown touching point projected on the second direction based on the voltage, and estimate a first projection position of the first unknown touching point and a second projection position of the second unknown touching point projected on the second direction according to the middle point projection position and the second distance.

In another aspect, the present invention provides a method for detecting a dual touching event adapted for use in a resistive touch panel. According to this method, when the dual touching event takes place, a first conducting layer and a second conducting layer of the resistive touch panel contact with each other at a first unknown touching point and a second unknown touching point. In addition, a first resistance value between two sides of the first conducting layer may be measured. Further, a first distance between a projection of the first unknown touching point and a projection of the second unknown touching point on a first direction may be estimated based on the first resistance value.

In view of the foregoing, the present invention can measure a resistance value of two sides of a conducting layer and estimate the dual touching event based on the resistance value. Further, an input signal for controlling an electronic device may be generated according to the resistance value.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A illustrates a touching principle of a conventional resistive touch panel module.

FIG. 1B illustrates a structure of conducting layers of a conventional four wire resistive panel module.

FIG. 1C illustrates a structure of conducting layers of a conventional five wire resistive panel module.

FIG. 1D illustrates a sensing module of FIG. 1B.

FIG. 2 illustrates a resistive touch panel module according to one embodiment of the present invention.

FIG. 3 illustrates positions of a dual touching event according one embodiment of the present invention.

FIG. 4 is a flow chart of a method of detecting a dual touching event according to one embodiment of the present invention.

FIG. 5 is a flow chart of another method of detecting a dual touching event according to one embodiment of the present invention.

FIG. 6 shows two touching points and a middle point therebetween according to one embodiment of the present invention.

FIG. 7 illustrates a resistive touch panel module according to another embodiment of the present invention.

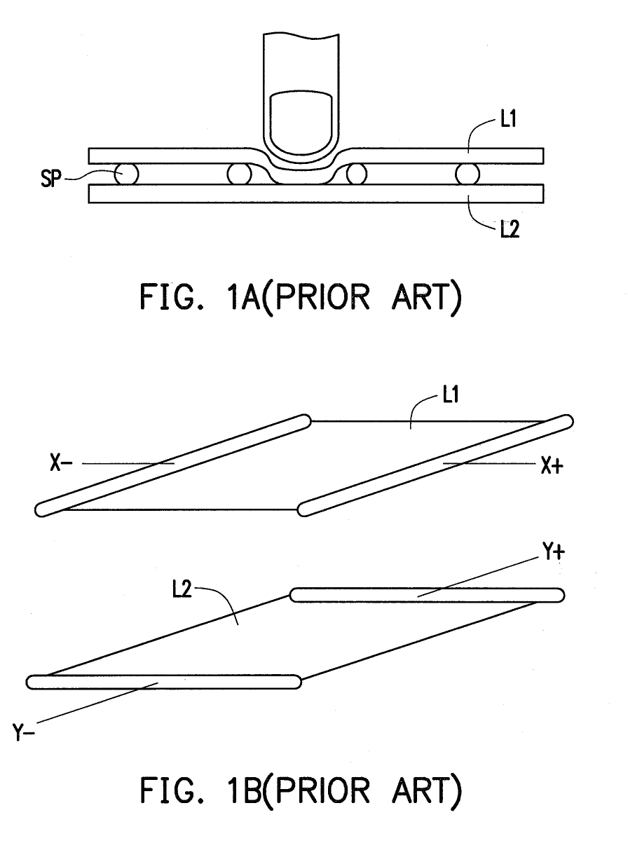

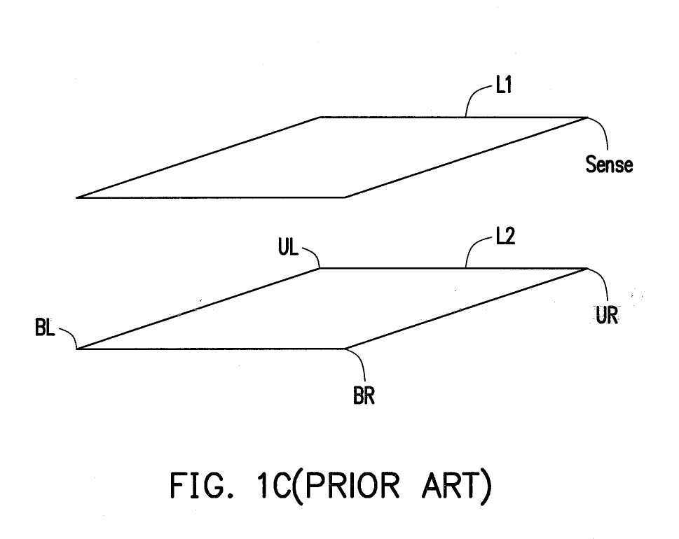

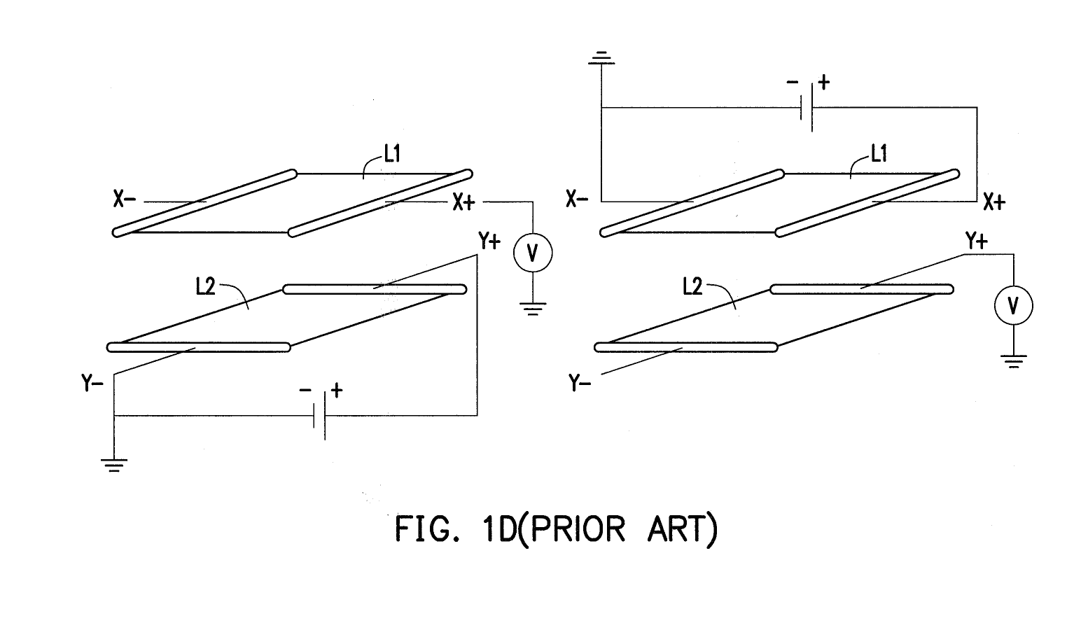

### DESCRIPTION OF THE EMBODIMENTS

Conventional resistive touch panel modules can only detect the touching point of a single touching event. When a dual touching event takes place, the conventional resistive touch panel module fails to respond.

In attempt to address the above-described problem, when a dual touching event occurs, embodiments of the present invention can estimate whether or not a dual touching event occurs according to a resistance variation of the resistive touch panel module. In addition, a distance between the two touching points along the X direction and the Y direction can be determined based on the resistance variations of upper and lower conducting layers, respectively. Further, positions of the two touching points can be estimated according to the distances of the two touching points. Embodiments of the present invention will be explained with reference to accompanying drawings in which like numerals refers to like steps.

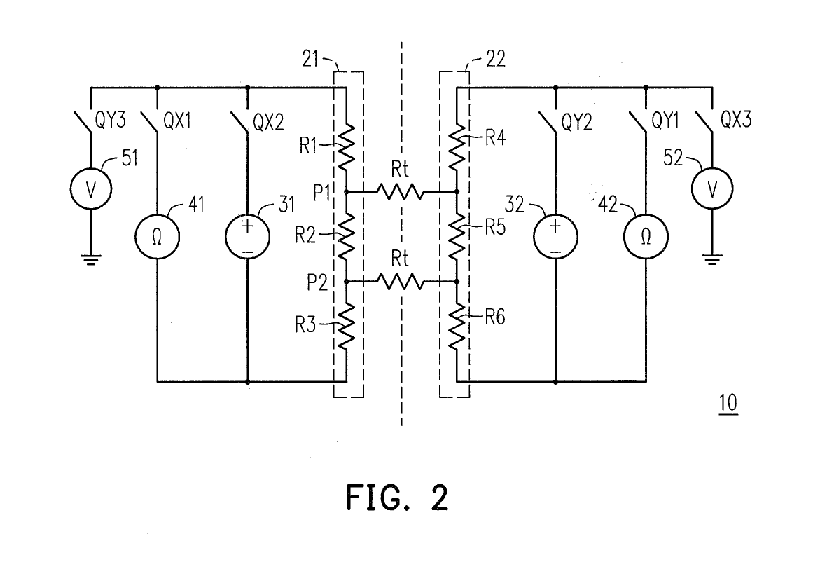

The present exemplary embodiment is described in conjunction with a four wire resistive touch panel module. FIG. 2 illustrates a resistive touch panel module according to one embodiment of the present invention. Referring to FIG. 2, the resistive touch panel module 10 may include touch panel conducting layers 21, 22, power sources 31, 32, a resistance value measuring unit, voltage detectors 51, 52, switches QX1-QX3, QY1-QY3, and an estimating unit (not shown). In the exemplary embodiment, the resistance value measuring units are implemented as resistance detectors 41, 42.

The power sources 31, 32 are coupled to the touch panel conducting layers 21, 22, respectively, for providing power to the touch panel conducting layers 21, 22. The resistance detectors 41, 42 are coupled to the touch panel conducting layers 21, 22, for measuring the resistance of the touch panel conducting layers 21, 22. The voltage detectors 51, 52 are coupled to the touch panel conducting layers 21, 22, for measuring the voltage of the touch panel conducting layers 21, 22.

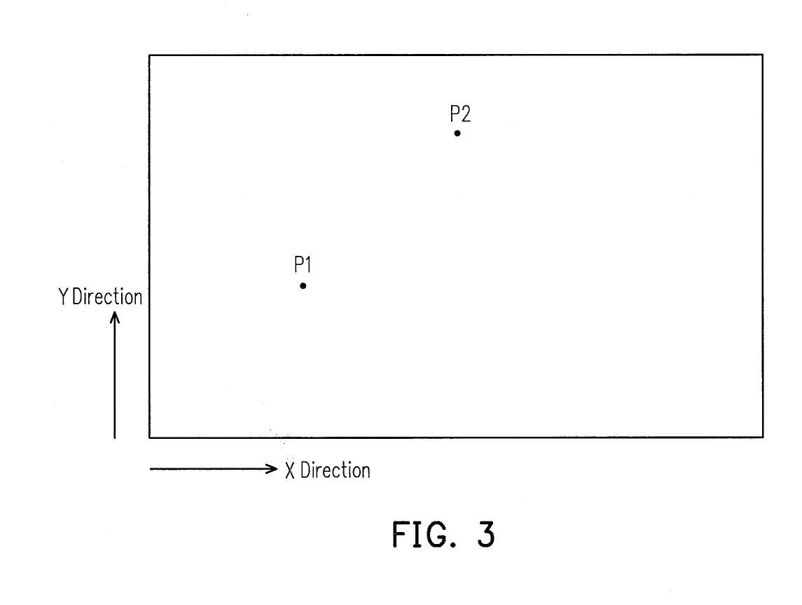

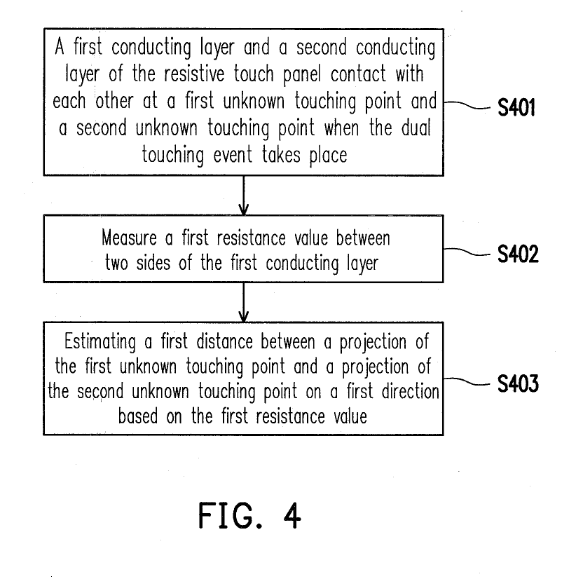

FIG. 3 illustrates positions of a dual touching event according one embodiment of the present invention. FIG. 4 is a flow chart of a method of detecting a dual touching event according to one embodiment of the present invention. Referring to FIGS. 2 to 4, it is assumed that the two touching points are at unknown touching points P1, P2, respectively. Each of the touch panel conducting layers 21, 22 may be considered as a string of resistors. More specifically, the resistance of the touch panel conducting layer 21 may be considered to be resistance R1+R2+R3, and the resistance of the touch panel conducting layer 22 may be considered as resistance R4+R5+R6. When two fingers touch the panel, the touch panel conducting layers 21, 22 contact with each other and therefore are conducted at corresponding positions of the unknown touching points P1, P2, and a resistance Rt is generated at each touching point.

When the touch panel conducting layers contact with each other, the contact resistance causes a parallel connection of resistors of the conducting layers, thus resulting in a variation of the resistance between two sides of the touch panel conducting layers. This resistance variation is proportional to the distance between the contacting points on the touch panel. Therefore, by measuring the resistance variation of the touch panel conducting layers, it can be detected whether or not there are two touching points on the touch panel. In addition, the resistance variation may also reflect the distance between the two touching points.

More particularly, when only one of the unknown touching points P1 and P2 is touched, the resistance between two sides of each of the touch panel conducting layers 21, 22 varies little. However, if the two unknown touching points P1 and P2 are touched simultaneously, the resistance of the two sides of the touch panel conducting layer 21 may be calculated as R1+R3+[R2×(2Rt+R5)/R2+(2Rt+R5)]. In other words, the resistance between the two sides of the touch panel conducting layer 21 may be considered as R1+R3+(resistance R2//2Rt+R5). As the distance between the projections of the unknown points P1 and P2 on the X direction becomes longer, the resistance R2 becomes larger and, therefore, the parallel connection between the resistance R2 and resistance 2Rt+R5 causes more resistance reduction. As such, the distance between the projections of the unknown touching points P1 and P2 on the X direction can be determined based on the variation of the resistance between the two sides of the touch panel conducting layer 21.

Likewise, if the two unknown touching points P1 and P2 are touched simultaneously, the resistance of the two sides of the touch panel conducting layer 22 may be calculated as R4+R6+[R5×(2Rt+R2)/R5+(2Rt+R2)]. In other words, the resistance between the two sides of the touch panel conducting layer 22 may be considered as R4+R6+(resistance R5//resistance 2Rt+R2). As the distance between the projections of the unknown points P1 and P2 on the Y direction becomes longer, the resistance R5 becomes larger and, therefore, the parallel connection between the resistance R5 and resistance 2Rt+R2 causes more resistance reduction. As such, the distance between the projections of the unknown touching points P1 and P2 to the Y direction can be determined based on the variation of the resistance between the two sides of the touch panel conducting layer 22.

In view of the foregoing, in the present embodiment, the resistance value between the two sides of the touch panel conducting layer 21 may be measured by the resistance detector 41 (step S402). The distance between the projections of the unknown points P1 and P2 on the X direction may then be estimated by the estimating unit according to the resistance value measured by the resistance detector 41 (step S403). More particularly, the estimating unit may obtain the distance between the projections of the unknown points P1 and P2 on the X direction by referring to a look-up table.

On the other hand, the resistance value between the two sides of the touch panel conducting layer 22 may be measured by the resistance detector 42 (step S402). The distance between the projections of the unknown points P1 and P2 to the Y direction may then be estimated by the estimating unit according to the resistance value measured by the resistance detector 42 (step S403). More particularly, the estimating unit may obtain the distance between the projections of the unknown points P1 and P2 on the Y direction by referring to a look-up table.

It is to be understood that an input signal for controlling an electronic device may be generated based on the resistance value measured by the resistance detector 41 or 42. For example, when the touch panel 10 displays a picture, the picture may be zoomed out or in according to the resistance value measured by the resistance detector 41 or 42. As another example, when the touch display 10 plays a video, the sound volume may be controlled according to the resistance value measured by the resistance detector 41 or 42.

While a possible exemplary configuration of the resistive touch panel module and the method of detecting a dual touching event have been illustrated in the above embodiment, it is to be understood that various companies may have different designs in the resistive touch panel module and the dual touching event detecting method and therefore the particular application of the present invention described above should not be regarded as limiting. In other words, any implementation that measures the resistance value between two sides of the conducting layer to estimate the dual touching event or to generate an input signal for controlling an electronic device complies with the spirit of the present invention. Several alternative embodiments are described below to further explain the spirit of the present invention so as to enable those skilled in the art to understand and practice the present invention.

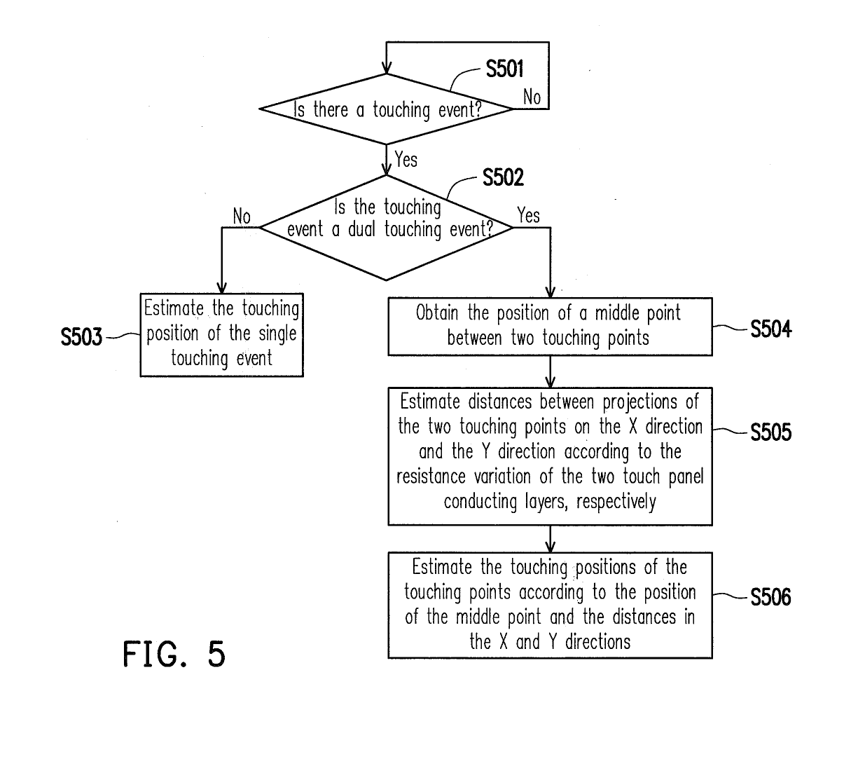

FIG. 5 is a flow chart of another method of detecting a dual touching event according to one embodiment of the present invention. Referring to FIG. 2, FIG. 3, and FIG. 5, in the present embodiment, it is likewise assumed that two touching points at P1, P2 are touched simultaneously. It can be first detected whether or not a touching event takes place at step S501. For example, this can be done by turning the switches QX2, QX3 on and turning the switch QY2 off. It is then determined whether or not the touch panel conducting layer 22 has a voltage by using the voltage detector 52 to measure the touch panel conducting layer 22. If it has a voltage, an occurrence of touching event can be confirmed and the method can proceed to step S502. If it does not have a voltage, it indicates there is no touching event and the method can continue detecting whether or not a touching event takes place (return step S501).

It is noted that the above described implementation of step S501 is only one exemplary embodiment that can be selected. In an alternative embodiment, the switches QY2, QY3 could be turned on and the switch QX2 could be turned off in step S501. It is then determined whether or not the touch panel conducting layer 21 has a voltage by using the voltage detector 51 to measure the touch panel conducting layer 21. If it has a voltage, an occurrence of touching event can be confirmed and the method can proceed to step S502. If it does not have a voltage, it indicates there is no touch event and the method can continue detecting whether or not a touching event takes place (return step S501).

It can be detected whether or not the touching event is a dual touching event at step S502. For example, the switch QX1 can be turned on and the resistance detector 41 can be used to measure the resistance between the two sides of the touch panel conducting layer 21 to see if the measured resistance is less than the resistance R1+R2+R3. If yes, it is confirmed that the touching event is a dual touching event and the method then proceeds to step S504; if not, it is confirmed that the touching event is a single touching event and the method then proceeds to step S503.

It is noted the above described implementation of step S502 is also one exemplary embodiment that can be selected. In an alternative embodiment, the switch QY1 can be turned on and the resistance detector 42 can be used to measure the resistance between the two sides of the touch panel conducting layer 22 to see if the measured resistance is less than the resistance R4+R5+R6. If yes, it is confirmed that the touching event is a dual touching event and the method then proceeds to step S504; if not, it is confirmed that the touching event is a single touching event and the method then proceeds to step S503.

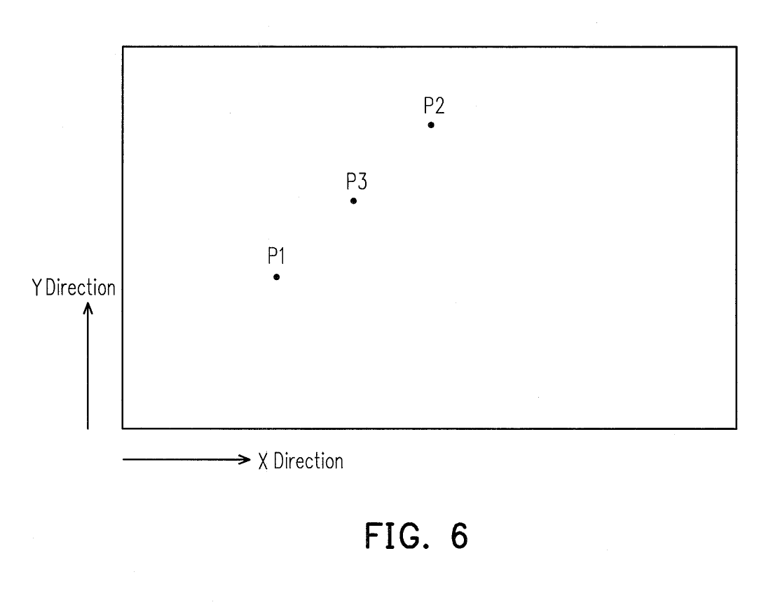

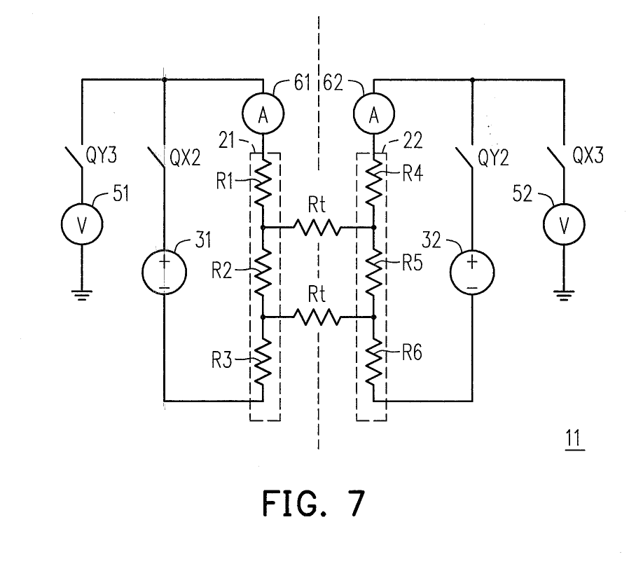

In the present embodiment, the implementation of step S504 is similar to the implementation of step S503 and, therefore, discussion of the implementation is made herein only with respect to step S504. FIG. 6 shows two touching points and a middle point according to one embodiment of the present invention. A projection position of a middle point P3 between the two unknown touching points P1, P2 projected on the X direction can be first obtained. For example, the switches QX2 and QX3 can be turned on and the switch QY2 can be turned off. The voltage detector 52 is then used to measure the voltage of the touch panel conducting layer 22. In the present embodiment, a larger voltage measured by the voltage detector 52 indicates that the middle point P3 is close to the left side of the panel. On the contrary, a smaller voltage measured by the voltage detector 52 indicates that the middle point P3 is close to the right side of the panel. As such, the estimating unit can receive the voltage measured by the voltage detector 52 and estimate the projection position of the middle point P3 on the X direction based on the received voltage. For example, the estimating unit can obtain the projection position of the middle point P3 on the X direction by referring to a look-up table.

Please notice here, the smaller voltage measured by the voltage detector 52 indicates that the middle point P3 is close to the right side of the panel is just an example here. In some embodiments, the smaller voltage measured by the voltage detector 52 may indicate that the middle point P3 is close to the left side of the panel. Also, the larger voltage measured by the voltage detector 52 indicates that the middle point P3 is close to the left side of the panel is just an example here, in some embodiments, the larger voltage measured by the voltage detector 52 may indicate that the middle point P3 is close to the right side of the panel.

A projection position of the middle point P3 on the Y direction is then obtained. For example, the switches QY2 and QY3 can be turned on and the switch QX2 can be turned off. The voltage detector 51 is then used to measure the voltage of the touch panel conducting layer 21. In the present embodiment, a larger voltage measured by the voltage detector 51 indicates that the middle point P3 is close to the bottom side of the panel. On the contrary, a smaller voltage measured by the voltage detector 51 indicates that the middle point P3 is close to the top side of the panel. As such, the estimating unit can receive the voltage measured by the voltage detector 51 and estimate the projection position of the middle point P3 on the Y direction based on the received voltage. For example, the estimating unit can obtain the projection position of the middle point P3 on the Y direction by referring to a look-up table. As such, the estimating unit can obtain the coordinate of the middle point P3.

Please notice here, the larger voltage measured by the voltage detector 51 indicates that the middle point P3 is close to the bottom side of the panel is just an example here. In some embodiments, the larger voltage measured by the voltage detector 51 may indicate that the middle point P3 is close to the top side of the panel. Also, the smaller voltage measured by the voltage detector 51 indicates that the middle point P3 is close to the top side of the panel is just an example here. In some embodiments, the smaller voltage measured by the voltage detector 51 may indicate that the middle point P3 is closed to the bottom side of the panel.

Distances between projections of the two touching points on the X direction and the Y direction can be estimated according to the resistance variation of the two touch panel conducting layers, respectively, in step S505. The implementation of the step S505 may be similar to those described in the above embodiment and therefore is not repeated herein.

At step S506, the touching positions of the touching points can be estimated according to the position of the middle point P3 and the distances in the X and Y directions obtained at step S505. For example, assuming that the coordinate of the middle point P3 is (X1, Y1), the distance between the projections of the two touching points on the X direction is 2Dₓ₁, and the distance between the projections of the two touching points on the Y direction is 2D_{y1}, then the coordinate of the two touching points in the X direction are X₁+D_{X1} and X₁-D_{X1}, respectively, and the coordinate of the two touching points in the Y direction are Y1+D_{Y1} and Y1-D_{Y1}. Therefore, it can be concluded that the coordinates of the two touching points are (X₁+D_{X1}, Y₁+D_{Y1}), (X₁-D_{X1}, Y₁-D_{Y1} or (X₁+D_{X1}, Y₁-D_{y1}), (X₁-D_{X1}, Y₁+D_{Y1}).

It is noted that the sequence of the steps shown in FIG. 5 is one exemplary embodiment that can be selected and thus should not be regarded as limiting. The sequence of the steps can be varied depending upon actual requirements. For example, in another embodiment, the method may proceed to step S503 after the step S501 is performed. The method then proceeds to step S502 where it can be determined that the touching position obtained at step S503 is a single touching position or a middle point position between two douching points. The method then can proceed to steps S505 and S506. In this way, the method can also achieve the same result.

While the present invention has been described in conjunction with a four wire resistive touch panel module in the above embodiments, the present invention is not intended to limit its application to particular embodiments herein. In other embodiments, the present invention can also be applied in a five wire resistive touch panel module or an eight wire resistive touch panel module or the like without departing from the spirit of the present invention.

In the above embodiments, while the resistance measuring unit of FIG. 2 is illustrated as resistance detectors 41, 42, this should not be regarded as limiting. The architecture of the resistive touch panel module 10 of FIG. 2 can be varied depending upon actual requirements. For example, FIG. 7 illustrates a resistive touch panel module according to another embodiment of the present invention. Referring to FIG. 2 and FIG. 7, the resistive touch panel module 11 of FIG. 7 is similar to the resistive touch panel module 10 of FIG. 2, the difference being that the resistive touch panel module 11 includes current detectors 61, 62 rather than the resistance detectors 41, 42 and switches QX1, QY1. In FIG. 7, as the switches QX2, QY3 are turned on, the voltage detector 51 may measure the voltage provided by the power source 31 and provides the measurement to the estimating unit (not shown). In addition, the current detector 61 may measure the current flowing through the touch panel conducting layer 21 and provide the measurement to the estimating unit. According to the Ohm's law, the estimating unit may obtain the resistance between the two sides of the touch panel conducting layer 21 based on the voltage measured by the voltage detector 51 and the current measured by the current detector 61.

Similarly, as the switches QY2, QX3 are turned on, the voltage detector 52 may measure the voltage provided by the power source 32 and provide the measurement to the estimating unit. In addition, the current detector 62 may measure the current flowing through the touch panel conducting layer 22 and provide the measurement to the estimating unit. According to the Ohm's law, the estimating unit may obtain the resistance between the two sides of the touch panel conducting layer 22 based on the voltage measured by the voltage detector 52 and the current measured by the current detector 62. As such, the present embodiment can achieve the similar results as in the above embodiment.

In summary, the present invention can measure the resistance between the two sides of the first conducting layer of the touch panel. In addition, the measured resistance value can be used to estimate a distance between projections of a first unknown touching point and a second unknown touching point on a direction or to generate an input signal for controlling the electronic device. Further, embodiments of the present invention can achieve the following results:
1. The coordinate of a middle point between the two touching points can be determined by detecting a voltage of a touch panel conducting layer.
2. The coordinate of the two touching points can be estimated according to the coordinate of the middle point and the distances of the projections of the two touching points on two directions.
3. The resistance detectors may be replaced by current detectors and voltage detectors.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A resistive touch panel module comprising:
a touch panel first conducting layer;
a touch panel second conducting layer, wherein the touch panel first conducting layer and the touch panel second conducting layer contact with each other at a first unknown touching point and a second unknown touching point;
a first power source coupled to the touch panel first conducting layer;
a first resistance measuring unit coupled to the touch panel first conducting layer for measuring a first resistance value between two sides of the touch panel first conducting layer; and
an estimating unit coupled to the first resistance measuring unit for estimating a first distance between a projection of the first unknown touching point and a projection of the second unknown touching point on a first direction based on the first resistance value.

2. The resistive touch panel module according to claim 1, further comprising a voltage detector coupled to the touch panel second conducting layer and the estimating unit for measuring a voltage of the touch panel second conducting layer and outputting the measured voltage to the estimating unit; wherein the estimating unit estimates a middle point projection position of a middle point between the first unknown touching point and the second unknown touching point projected on the first direction based on the voltage, and estimates a first projection position of the first unknown touching point and a second projection position of the second unknown touching point projected on the first direction according to the middle point projection position and the first distance.

3. The resistive touch panel module according to claim 1, wherein the resistance measuring unit comprises a resistance detector coupled to the two sides of the touch panel first conducting layer for measuring the first resistance value.

4. The resistive touch panel module according to claim 1, wherein the resistance measuring unit comprises a current detector coupled to the touch panel first conducting layer for measuring a first current flowing through the touch panel first conducting layer; and a computing unit coupled to the current detector and the first power source to compute the first resistance value according to the first current and a voltage provided by the first power source.

5. The resistive touch panel module according to claim 1, further comprising:
a second power source coupled to the touch panel second conducting layer; and
a second resistance measuring unit coupled to the touch panel second conducting layer and the estimating unit for measuring a second resistance value between the two sides of the touch panel second conducting layer and outputting the second resistance value to the estimating unit; wherein the estimating unit estimates a second distance between a projection of the first unknown touching point and a projection of the second unknown touching point on a second direction based on the second resistance value.

6. The resistive touch panel module according to claim 5, further comprising a voltage detector coupled to the touch panel second conducting layer and the estimating unit for measuring a voltage of the touch panel first conducting layer and outputting the measured voltage to the estimating unit; wherein the estimating unit estimates a middle point projection position of a middle point between the first unknown touching point and the second unknown touching point projected on the second direction based on the voltage, and estimates a first projection position of the first unknown touching point and a second projection position of the second unknown touching point projected on the second direction according to the middle point projection position and the second distance.

7. A method for detecting a dual touching event adapted to a resistive touch panel, comprising:
contacting a first conducting layer with a second conducting layer of the resistive touch panel at a first unknown touching point and a second unknown touching point when the dual touching event takes place;
measuring a first resistance value between two sides of the first conducting layer; and
estimating a first distance between a projection of the first unknown touching point and a projection of the second unknown touching point on a first direction based on the first resistance value.

8. The method for detecting a dual touching event according to claim 7, further comprising:
measuring a voltage of the second conducting layer;
estimating a middle point projection position of a middle point between the first unknown touching point and the second unknown touching point projected on the first direction based on the voltage; and
estimating a first projection position of the first unknown touching point and a second projection position of the second unknown touching point projected on the first direction according to the middle point projection position and the first distance.

9. The method for detecting a dual touching event according to claim 7, wherein measuring the first resistance value between the two sides of the first conducting layer comprises:
measuring a first current flowing through the first conducting layer; and
computing a first resistance value according to the first current and a voltage provided to the first conducting layer.

10. The method for detecting a dual touching event according to claim 7, further comprising:
measuring a second resistance value between the two sides of the second conducting layer; and
estimating a second distance between a projection of the first unknown touching point and a projection of the second unknown touching point on a second direction based on the second resistance value.

11. The method for detecting a dual touching event according to claim 10, further comprising:
measuring a voltage of the first conducting layer and outputting the measured voltage to the estimating unit;
estimating a middle point projection position of a middle point between the first unknown touching point and the second unknown touching point projected on the second direction based on the voltage; and
estimating a first projection position of the first unknown touching point and a second projection position of the second unknown touching point projected on the second direction according to the middle point projection position and the second distance.
